(19) United States
(12) Patent Application Publication
(10) Pub. No.: US 2010/0065657 A1
(43) Pub. Date: Mar. 18, 2010

(54) Sprayer Structure

(76) Inventor: Ping-Chuan Lee, Tucheng City (TW)

Correspondence Address: HDLS Patent & Trademark Services, P.O. BOX 220746, CHANTILLY, VA, 20153-0746, US

(21) Appl. No.: 12/209,240

(22) Filed: Sep. 12, 2008

(51) Int. Cl. B05B 3/10

(52) U.S. Cl. 239/224

(57) ABSTRACT

A sprayer structure includes a hollow seat body, wherein several blow holes are provided at the top surface of the hollow seat body, a water wheel is provided within the hollow seat body, a corresponding through-hole is provided on the upper and lower surfaces of the hollow seat body, an inlet pipe shaft is inserted through the through-hole, one end of the inlet pipe shaft is closed, while its another end is connected with a water pipe, and wherein an outlet port is provided on the inlet pipe shaft, a hollow water-guiding part is inserted into the inlet pipe shaft, whereby the outlet port of the inlet pipe shaft is positioned within the hollow water-guiding part; by assembling the above-described components, the sprayer structure of the invention can be fabricated.

### BACKGROUND OF THE INVENTION

1. Field of the Invention

The invention relates to a sprayer structure, and in particular, to a sprayer structure characterized in that a purpose of automatic rotary distributing is achieved by impinging a water wheel within a hollow seat body with a water flow.

2. Description of the Prior Art

As well-known, there are many types of conventional sprayer. For example, a spin nozzle 1 (as shown in FIG. 1) had been developed with main structure characterized by: a base 11, an upper semispherical shell 12, a lower semispherical shell 13, an end plate 14 and the like; wherein the lower end of the base 11 is a hollow connecting section 111 linking an outlet end, wherein a annular baffle 112 is provided above the hollow connecting section 111, and a hollow cylinder 113 is provided above the annular baffle 112, and wherein a deflection through-hole 1131 is provided at a proper position on the middle side of the hollow cylinder 113; wherein the hollow cylinder 113 has an open end; a symmetrical upper semispherical shell 12 and a lower semispherical shell 13 form together a hollow sphere, provided at its center with through-holes 121, 131 that are symmetrical with the hollow cylinder 113; the upper semispherical shell 12 is provided thereon with a through-hole 121, which, after the hollow sphere is assembled, can have its through-holes 121, 131 engaged into the hollow cylinder 113 of the base 11 such that the sphere can be in a rotation state on the hollow cylinder 113; an end plate 14, provided thereon with a small through-hole 141, which, after the hollow sphere is engaged into the hollow cylinder 113, is closed at the open end of the hollow cylinder 113.

While the spin nozzle 1 can achieve automatically the rotary distribution effect by means of deflective hydraulic pressure, its distribution performance can not be as good as expected, since the nozzle is brought to rotate by means of the hydraulic pressure, where the friction force between the nozzle 1 and the hydraulic phase is insufficient, as well as is too small relative to the automatic rotational force of the nozzle 1.

In view of the foregoing, the above-described article has still many disadvantages, is not a perfect design and needs to be improved urgently.

The inventor had learned about various disadvantages derived from the above-mentioned spin nozzle and devoted urgently to improve and innovate it, which finally, after studying diligently and intensively for many years, had developed successfully the sprayer structure of the invention.

### SUMMARY OF THE INVENTION

One object of the invention is to provide a sprayer structure characterized in that, by way of using a hollow water-guiding part in conjunction with a water wheel, water flows out of the water-guiding port of the hollow water-guiding par, and then impinges strongly against the swivel disk blade of the water wheel, since the water wheel is engaged with the hollow seat body with each other, the hollow seat body will be brought to rotate automatically as the water wheel starts to rotate.

The sprayer structure that can achieve the object of the invention is consisted of a hollow seat body, a water wheel, a inlet pipe shaft, an elastic body, two leakage-proof sets, two wear collar sets; wherein, the hollow seat body is formed by combining an upper shell body and an lower shell body, and corresponding through-holes are provided on the upper and lower shell bodies, respectively, wherein several blow holes are provided on the top surface of the upper shell body, while several protruding ribs are provided on the inner surface of the lower shell body; wherein the water wheel is formed by combining a water wheel swivel disk with a cover plate mutually, wherein water guiding blades are laid over the water wheel swivel disk, and further, several notches are provided concavely over the peripheries of the water wheel swivel disk and the cover plate in a manner that the notches are engaged with the protruding ribs on the lower shell body; wherein the inlet pipe shaft is constructed by providing on the connecting section with a hollow water-guiding part, penetrating an upper connecting section through the hollow water-guiding part and then combining with the lower connecting section; wherein the upper connecting section is provided thereon with an outlet port, and a jointing part is provided on the rear end of the lower connecting section; wherein a water-guiding port is provided at both end of the hollow water-guiding part, respectively; wherein the inlet pipe shaft penetrates the through-hole of the hollow seat body in a manner that the hollow seat body can rotate over the inlet pipe shaft, while the outlet port on the inlet pipe shaft is positioned within the hollow water-guiding part; wherein, as water flows into inlet pipe shaft through a line, it will enter the hollow water-guiding part via the outlet port of the inlet pipe shaft, exits from water-guiding ports on both ends of the hollow water-guiding part and impinges against the water wheel within the hollow seat body, and as the water wheel swivel disk in the water wheel begins to rotate automatically upon being affected by the impinging of the water flow, and water injected therein is sprayed outwardly through the blow hole on the top surface, thereby achieves purposes of rotating automatically and spraying water.

These features and advantages of the present invention will be fully understood and appreciated from the following detailed description of the accompanying Drawings.

### BRIEF DESCRIPTION OF THE DRAWINGS

FIG. 1 is a schematic structural view of a conventional spin nozzle;

FIG. 2 is a pictorial exploded view of the inventive sprayer structure;

FIG. 3 is a pictorial combined view of the sprayer structure;

FIGS. 4A and 4B are schematic views showing the operation of the sprayer structure;

FIG. 5 is a schematic view showing the status of the application of the sprayer structure;

FIGS. 6A, 6B, 6C, and 6D are schematic views showing various types of layout with respect to the shell body blow hole of the sprayer structure;

FIG. 7 is a schematic view of the sprayer structure according to another embodiment of the invention; and

FIG. 8 is a schematic view of the sprayer structure according to a further embodiment of the invention.

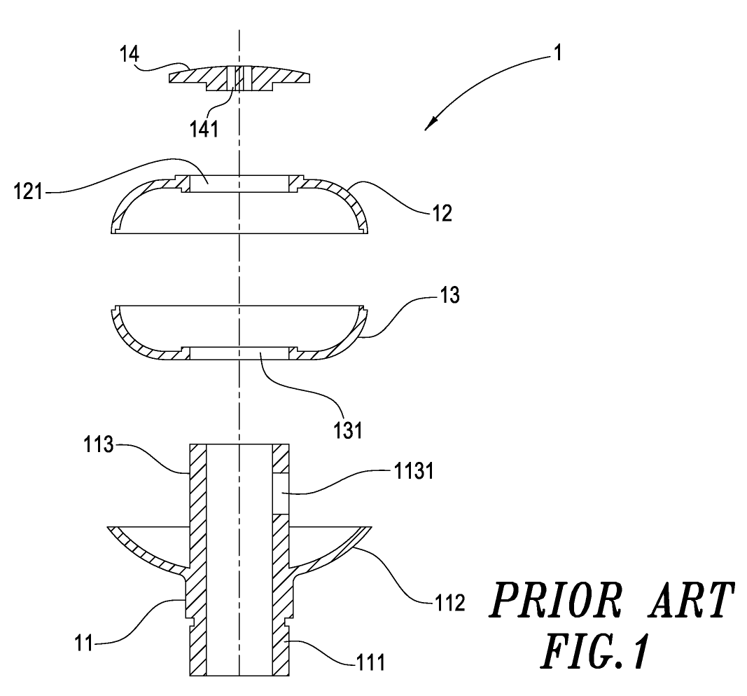

### DETAILED DESCRIPTION OF THE PREFERRED EMBODIMENT

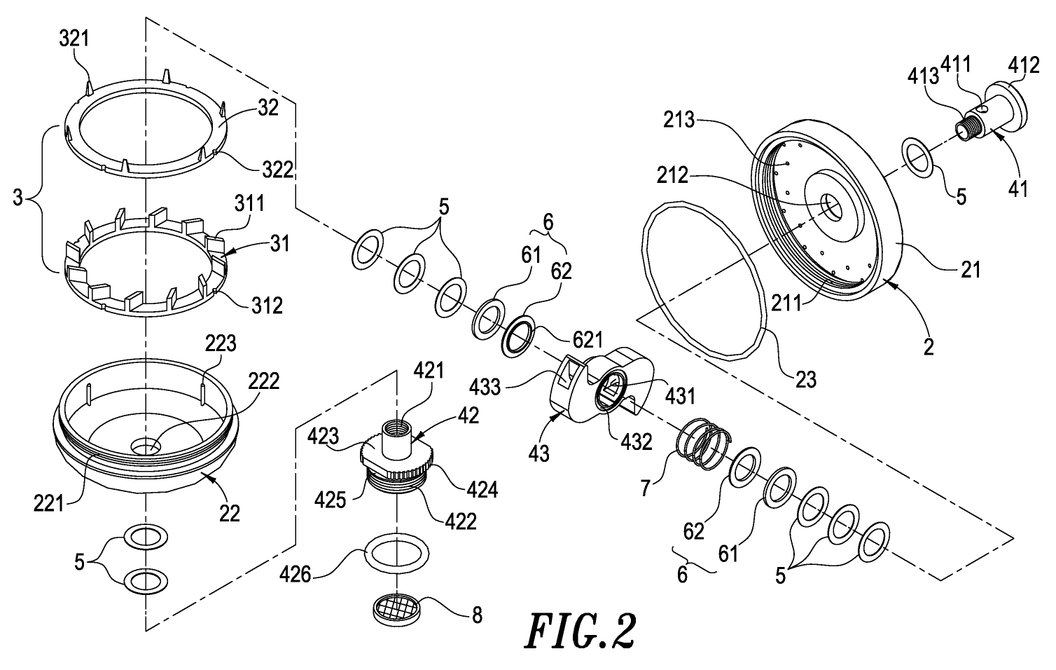

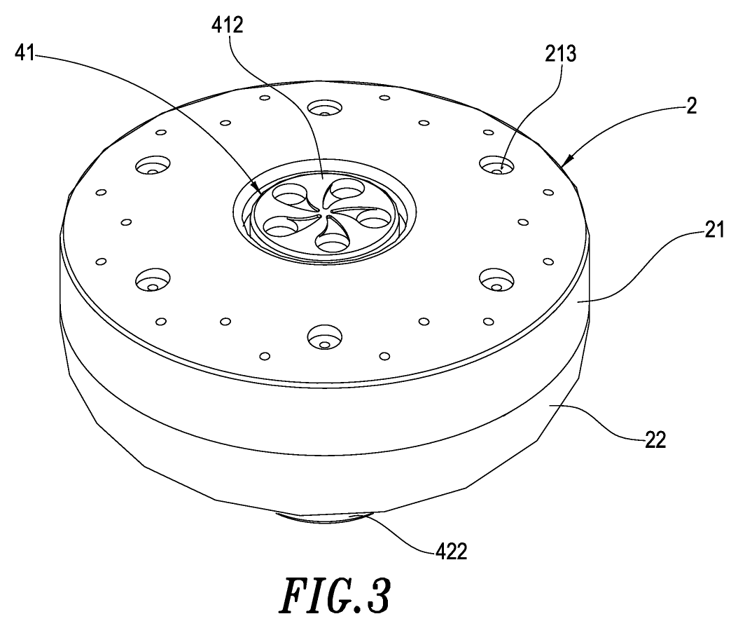

Referring to FIGS. 2 and 3, the sprayer structure provided by the invention comprises mainly:

a hollow seat body 2, the hollow seat body 2 comprising an upper shell body 21 and a lower shell body 22, wherein corresponding threads 211, 221 are provided along the peripheries of the upper and lower shell bodies 21, 22 in a manner that the upper and lower shell bodies 21, 22 can be engaged through the threads and form a hollow seat body 2, and further, a plastic ring 23 is provided at that threaded joint; furthermore, corresponding through-holes 212, 222 are provided on the upper and lower shell bodies 21, 22, respectively; in addition, several blow holes 213 are provided on the top surface of the upper shell body 21, as well as more than one protruding rib 223 are laid on the periphery of the inner surface of the lower shell body 22;

a water wheel 3, the water wheel 3 comprising a water wheel swivel disk 31 and a cover plate 32, wherein more than at least one blade 311 is laid on the water wheel swivel disk 31, and wherein the blade 311 is laid on the water wheel swivel disk 31 in a slanting manner, while a plurality of top supporting posts 321 are laid on the upper end of the cover plate such that the top supporting posts 321 can support upwardly the inner wall surface of the upper shell body 21 in order to prevent the displacement of the water wheel 3; and wherein more than at least one notches 312, 322 are provided over the periphery of the water wheel swivel disk 31 and cover plate 32 in a manner that each of notches 312, 322 can be engaged with each of corresponding protruding ribs 223 of the lower shell body 22;

an inlet pipe shaft 4, the inlet pipe shaft 4 comprising an upper connecting section 41, a lower connecting section 42 and a hollow water-guiding part 43, wherein outlet ports 411 are provided on the upper connecting section 41; wherein the upper connecting section 41 has a open front end, and its tail end is an open end; in addition, a cap rim 412 is provided on the front end of the upper connecting section 41, and a thread 413 is provided on its tail end, while the front and rear ends of the lower connecting section 42 are open ends; wherein a thread 421 is provided in the front end of the lower connecting section 42, a jointing part 422 is provided on its tail end, and a locking tab 423 extends at its middle end, where an anti-skid line 424 is provided on the locking tab 423, a ring groove 425 is provided between the locking tab 423 and the jointing part 422, as well as a plastic ring 426 is provided on the ring groove 425; further, a hollow water-guiding part 43 is inserted between the upper connecting section 41 and the lower connecting section 4, where the hollow water-guiding part 43 is in a slight S-shaped, is positioned above the hollow water-guiding part 43, has a joint hole 431 provided at its lower side, and a rabbet 432 provided concavely at the outer periphery of the joint hole 431 at upper side; wherein the joint hole 431 at the upper side of the hollow water-guiding part 43 is engaged with the tail end of the upper connecting section 41, while the joint hole 431 at the lower side of the hollow water-guiding part 43 is engaged with the front end of the lower connecting section 42; further, a water-guiding port 433 is provided at both sides of the hollow water-guiding part 43, respectively, where the water-guiding port 433 is provided at the corresponding position with respect to the blade 311 of the water wheel swivel disk 31; wherein the tail end of the upper connecting section 41 penetrates the through-hole 212 on the upper shell body 21 of the hollow seat body 2 such that the cap rim 412 at the top end of the upper connecting section 41 is hold against the top surface of the upper shell body 21; furthermore, a wear collar 5 is provided between the cap rim 412 and the upper shell body 21, and a plurality of wear collars 5 and a leakage-proof set 6 are inlaid in this order from the tail end of the upper connecting section 41 in a manner that the wear collar 5 stays against the inner wall surface of the upper shell body 21; and wherein an elastic body 7 is inlaid at the tail end of the upper connecting section 41 in a manner that one end of the elastic body 7 stays against the leakage-proof set 6, while another end is inserted within the rabbet 432 on the hollow water-guiding part 43;

wherein the top end of the lower connecting section 42 penetrates the lower shell body through-hole 222 of the hollow seat body 2 such that the locking tab 423 of the lower connecting section 42 is hold against the lower surface of the lower shell body 22; wherein a plurality of wear collars 5 are provided between the lower connecting section 42 and the lower shell body 22, and in addition, a plurality of wear collars 5 and a leakage-proof set 6 are inlaid successively from the top end of the lower connecting section 42 in a manner that the leakage-proof set 6 is hold against the lower side of the hollow water-guiding part 43; finally, threads 413, 421 on ends of the upper and lower connecting sections 41, 42 are engaged into the inlet pipe shaft 4, where the elastic body 7 is in a compressed state, thereby an elastic force is generated, and through that elastic force, it is hold against the leakage-proof set 6 and the wear collar 5 positioned on the upper connecting section 41, the lower connecting section 42 and the hollow water-guiding part 43, and as such, the through-holes 212, 222 on the upper and lower shell bodies 21, 22 can be closed through the leakage-proof set 6 and the wear collar 5 to achieve the purposes of stopping release and preventing leakage.

Additionally, the elastic body 7 may be a spring, whereby, as the upper and lower shell bodies 21, 22 and the upper and lower connecting sections 41, 42 are engaged threadedly with each other, the spring will be compressed to generate an elastic force.

Further, the leakage-proof set 6 is composed of a packing ring 61 and a leakage-proof ring 62, wherein a flange 621 extends from the leakage-proof ring 62, where the flange 621 is used for the engagement of the elastic body 7 and one end of the hollow water-guiding part 43, so as to hold upwardly and securely the leakage-proof set 6 and a plurality of wear collars 5.

Furthermore, a strainer 8 can be provided in the open rear end of the lower connecting section 42 of the inlet pipe shaft 4 for the filtration of water.

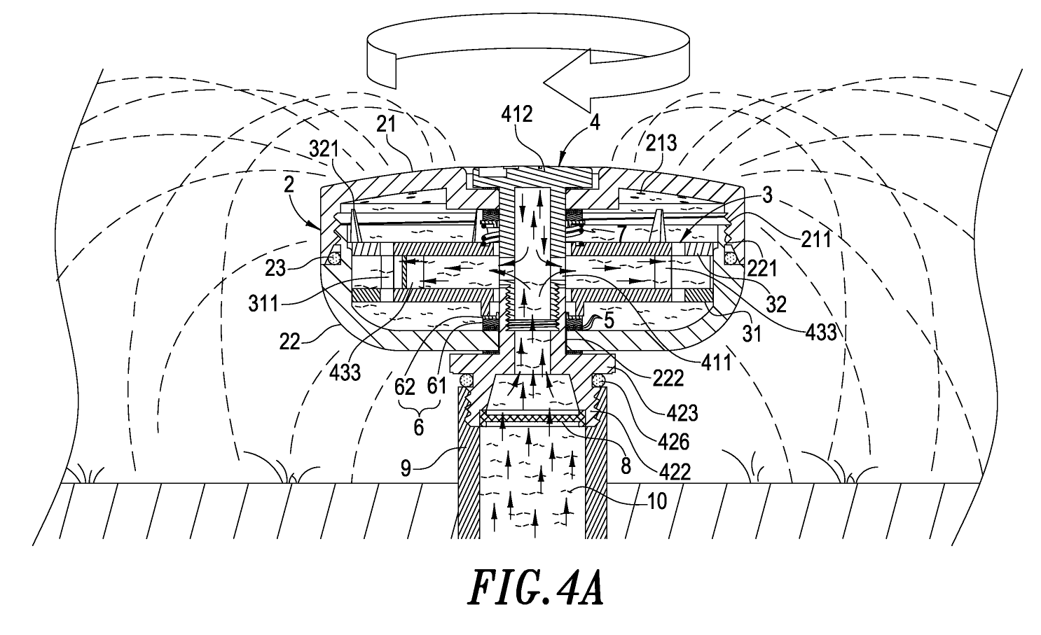

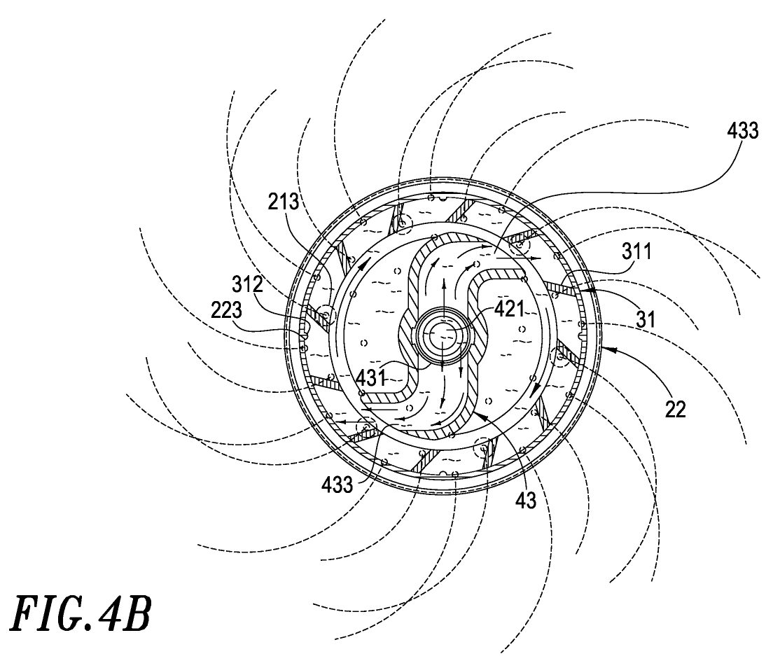

Referring to FIGS. 4A and 4B, schematic views showing the operation of the sprayer structure, the operation comprises of fastening the jointing part 422 on the tail end of the lower connecting section 42 of the inlet pipe shaft 4 with the outlet port of the water pipe 9 on the garden turf, thereby water flows from the outlet port 411 of the inlet pipe shaft 4 into the hollow water-guiding part 43, and flows out of the water-guiding port 433 on both sides of the hollow water-guiding part 43 and impinges continuously the blade 311 of the water wheel swivel disk 31, wherein, since a great water flow enters the hollow seat body 2 through water-guiding port 433 having small bore, the strength of the water flow entering the hollow seat body 2 becomes increased, and consequently, the water wheel swivel disk 31 will begin to rotate owing to the influence from the strong impingement of the water flow, and at the same time, since the protruding ribs 223 on the lower shell body 22 of the hollow seat body 2 are engaged with the notches 312, 322 on the water wheel swivel disk 31 and the cover plate 32, the automatic rotation of the hollow seat body 2 will be brought to occur synchronously, and water 10 injected therein will be sprayed out continuously from blow holes 213 on top surface of the upper shell body 21, thereby achieve purposes of automatic rotation and water spraying, and further, by the provision of wear collars 5, wear of the hollow seat body 2 is not prone to occur even after rotating for a long period of time.

Additionally, through-holes 212, 222 of the hollow seat body 2 can be closed tightly through leakage-proof set 6 such that water 10 injected into the hollow seat body 2 can be sprayed only out of blow holes 213 and hence can prevent the waste of water source.

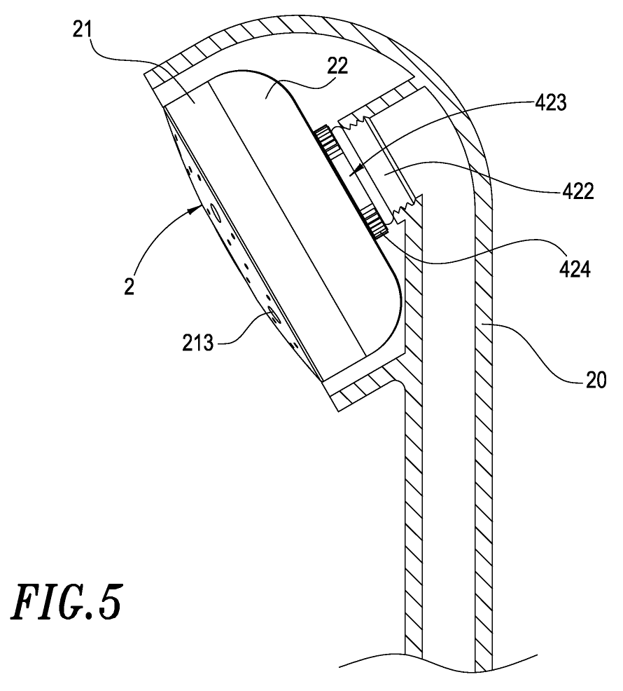

Referring to FIG. 5, it is a schematic view showing the application of the inventive sprayer structure. As shown in FIG. 5, the jointing part 422 at the tail end of the lower connecting section 42 of the inlet pipe shaft 4 is fastened threadedly with the shower head grip 20 such that the sprayer structure of the invention can be used as a sprayer of a shower head. As such, the sprayer structure according to the invention can be applied in fields of sanitary wares, horticulture or SPA massage.

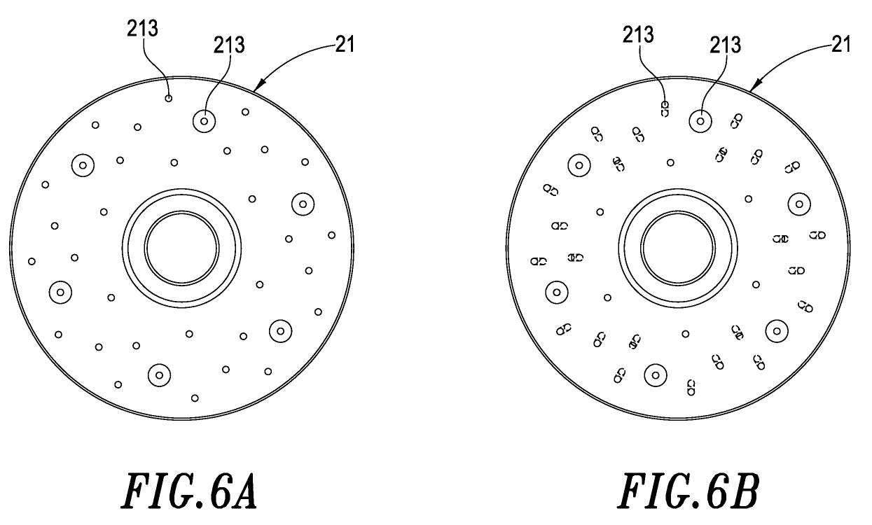

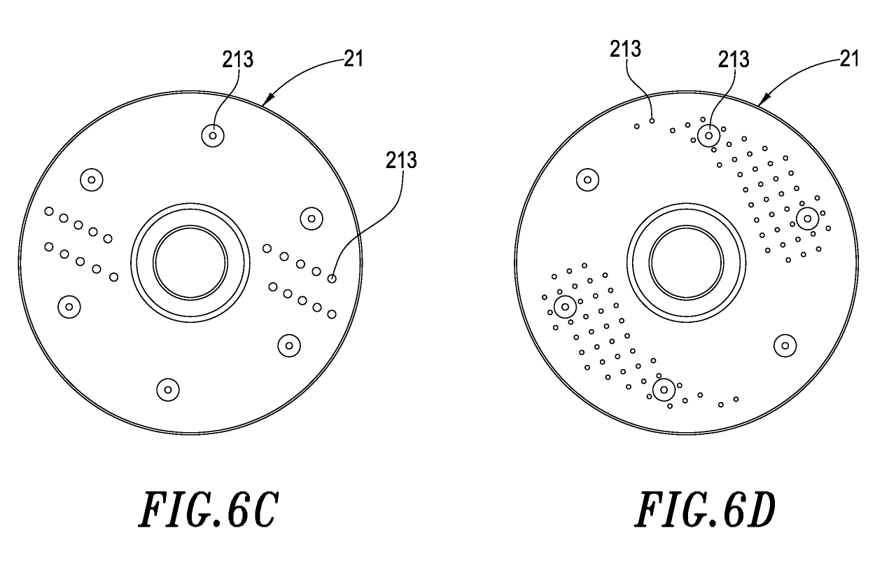

Referring to FIGS. 6A, 6B, 6C, and 6D, they are schematic view showing various types of layout for blow holes on the upper shell body of the sprayer structure. Different laying position of the blow hole 213 on the upper shell body 21 will yield different spraying effect. As shown in FIG. 6A, blow holes 213 of the upper shell body 21 are presented as straight holes, and are laid on the upper shell body 21 such that water 10 can be jetted straightly and sprayed center on. As shown in FIG. 6B, blow holes 213 of the upper shell body 21 have same laying positions as those of blow holes 213 of FIG. 6A, but different in that these blow holes 213 are oblique holes that make the spraying range of water 10 be appropriate, spray in multiple angles, and the water thus sprayed be more continuous and denser. As shown in FIG. 6C, blow holes 213 of the upper shell body 21 are straight holes, but the blow holes 213 are laid to be concentrated over local sites on both sides about the center of the top surface of the upper shell body 21, and also the number of blow holes 213 thus laid is much less, while those open holes are bigger, which lead water 10 not only to be able to jet straightly, but also render the force exhibited by water 10 is more strong and concentrated, as well as can be applied effectively on SPA or hydrotherapy machine. As shown in FIG. 6D, the blow holes 213 of the upper shell body 21 assume a straight hole shape, and the blow holes 213 are laid concentrated over both sides about the center of the upper shell body 21, but the number of blow holes 213 thus-laid is higher, with less bore, which enable water 10 to be sprayed intermittently, and yield finer and denser spout, and this make possible its application in SPA or common shower.

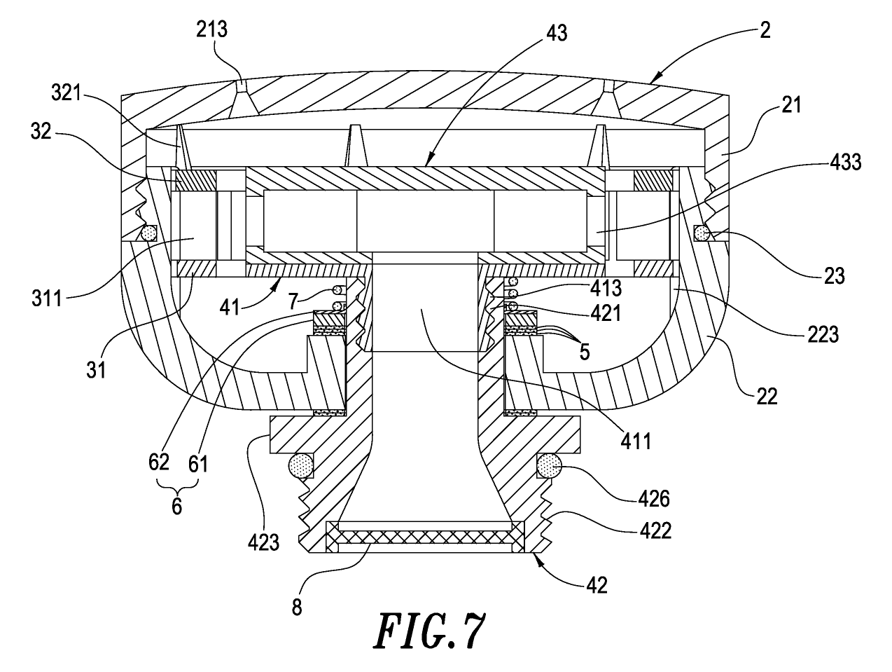

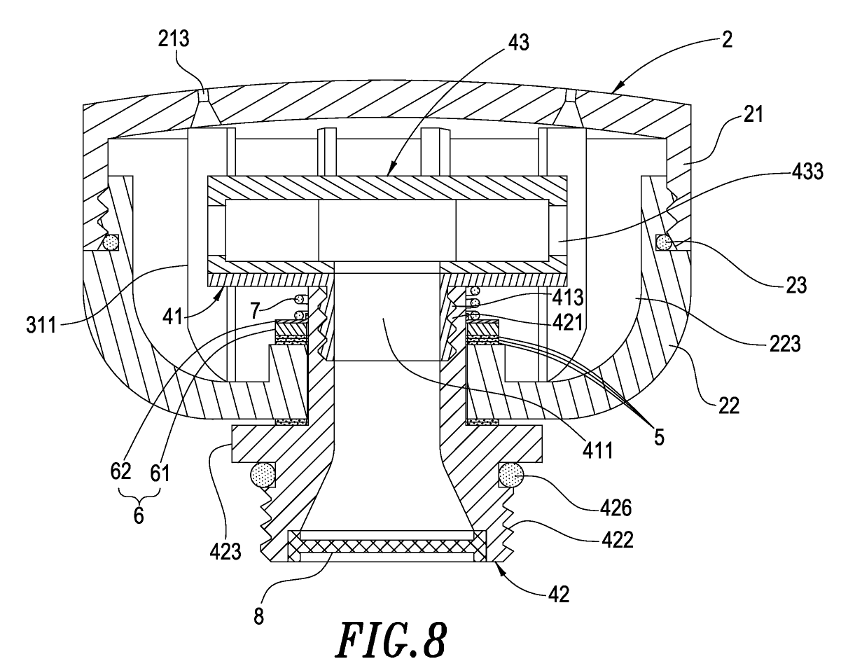

Referring to FIGS. 7 and 8, they are exploded view of various embodiments according to the inventive sprayer structure. As shown in FIG. 7, the sprayer structure is approximately same as that shown in FIG. 2 with exception in that no through-hole 212 is provided on the upper shell body 21 to allow the insertion of upper connecting section 41 into this through-hole 212. In stead, the upper connecting section 41 is engaged at the lower side of the hollow water-guiding part 43, the outlet port 411 of the upper connecting section 41 is arranged at a position corresponding to the joint hole 431 at the lower side of the hollow water-guiding part 43, and the thread 413 at lower side of the hollow water-guiding part 43 is engaged threadedly with the thread 421 of the lower connecting section 42. Further, as shown in FIG. 8, the protruding rib 223 provided originally in the lower shell body 22 is no longer present here, but blades 311 of water wheel 3 shown in FIG. 7 extends directly and upwardly from the periphery of the lower shell body 22, and the top end of the blade 311 is allowed to be hold against the inner shell surface of the upper shell body 21, thereby, the engagement of water wheels 3 in FIG. 2 and 7 with protruding rib 223 in the lower shell body 22 can be eliminated.

As such, by means of structures according to these two embodiments described above, purposes of automatic rotation and water spraying can be achieved as well, and at the same time, material cost can be decreased due to fewer components used in these two embodiments.

In summary, the sprayer structure provided according to the invention has following advantages over other conventional technique:

1. In the sprayer structure according to the invention, a hollow water-guiding part is used in combination with a water wheel in a manner that water flows out of a water-guiding port of the hollow water-guiding part and impinges strongly against blades of a water wheel swivel disk in the water wheel, thereby, since the water wheel is engaged with the hollow seat body, as the water wheel begins to rotate, a hollow seat body will be brought synchronously to rotate automatically.

2. In the sprayer structure according to the invention, a jointing part is provided at the rear end of an inlet pipe shaft, wherein the jointing part is able to connect with various articles, which makes the sprayer to be applicable in fields of a shower head, a hydrant, a sprinkler in garden horticulture, Jacuzzi sprayer and the like.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A sprayer structure, comprising:
a hollow seat body, wherein a through-hole is provided at the lower surface of said hollow seat body, and a plurality of blow holes are provided over the top surface thereof;
a water wheel, wherein said water wheel can be secured on the inner surface of said hollow seat body;
an inlet pipe shaft, wherein the upper end of said inlet pipe shaft is closed, its lower end is a water inlet, and an outlet port is provided near the upper end; wherein the upper end of the inlet pipe shaft is inserted into the hollow seat body through a through-hole provided at the lower surface of the hollow seat body, such that the outlet port of the inlet pipe shaft is positioned in the hollow seat body, and the through-hole of the hollow seat body is sealed tightly by means of the inlet pipe shaft;
a hollow water-guiding part, wherein a joint hole is provided at the lower surface of said hollow water-guiding part, and water-guiding ports are provided at both sides; wherein the joint hole of the hollow water-guiding part is engaged securely with the upper portion of the inlet pipe shaft such that the outlet port of the inlet pipe shaft is positioned within the hollow water-guiding part, while water-guiding ports at both sides of the hollow water-guiding part are positioned corresponding to the water wheel.

2. A sprayer structure as recited in claim 1, wherein a plurality of protruding ribs are laid over the periphery of inner wall surface of said hollow seat body, and notches are provided over periphery of the water wheel, where said notches are engaged with said protruding ribs in a manner that the water wheel is secured at the inner wall surface of the hollow seat body.

3. A sprayer structure as recited in claim 2, wherein said water wheel comprises a water wheel swivel disk and a cover plate, a plurality of blades are laid on said water wheel swivel disk, said blades are laid oblique over said water wheel swivel disk, and a plurality of notches are provided concavely over the periphery of said water wheel swivel disk and cover plate.

4. A sprayer structure as recited in claim 3, wherein the top surface of said cover plate extends into top supporting posts that hold upwardly against the top inner surface of the hollow shell body, thereby prevent the displacement of the water wheel.

5. A sprayer structure as recited in claim 1, wherein said water wheel and said hollow seat body can be fabricated integrally.

6. A sprayer structure as recited in claim 5, wherein said water wheel comprises a plurality of blades.

7. A sprayer structure as recited in claim 1, wherein said inlet pipe shaft comprises a upper connecting section and a lower connecting section, an outlet port is provided near the middle section of said upper connecting section, the front end of said upper connecting section is a closed end and forms a cap rim, its rear end is an open end and forms a thread, and the front and rear ends of said lower connecting section are open ends, a thread is formed at the front end of said lower connecting section, a jointing part is provided at its rear end, and a locking tab is extended from its middle portion; wherein a through-hole is provided at the upper surface of said hollow seat body, and the upper connecting section is inserted into the hollow seat body through the through-hole, such that the outlet port of the upper connecting section is positioned within the hollow seat body, the lower connecting section is inserted into the hollow seat body through the through-hole at the lower surface of the hollow seat body, thereby the outlet port of the inlet pipe shaft is positioned within the hollow seat body, while the thread at the rear end of the upper connecting section is engaged threadedly with the thread at the front end of the lower connecting section.

8. A sprayer structure as recited in claim 1, wherein said inlet pipe shaft comprises a upper connecting section and a lower connecting section, an outlet port is provided on said upper connecting section, and a thread is provided at the rear end of the upper connecting section, the front and rear ends of the lower connecting section are open ends, a thread is formed at the front end of the lower connecting section, a jointing part is provided at its rear end, and a locking tab is extended from its middle portion; wherein the top surface of said upper connecting section is combined securely with said hollow water-guiding part, the thread at the rear end of the upper connecting section is engaged threadedly with the thread at the front end of the lower connecting section in a manner that the upper connecting section is positioned within the hollow seat body, while water-guiding ports at both sides of the hollow water-guiding part are at positions corresponding to water wheel.
